(19) United States
(12) Patent Application Publication
(10) Pub. No.: US 2015/0339262 A1
(43) Pub. Date: Nov. 26, 2015

(54) OUTPUT SIGNAL-TO-NOISE WITH MINIMAL LAG EFFECTS USING INPUT-SPECIFIC AVERAGING FACTORS

(71) Applicant: Kaiser Optical Systems Inc., Ann Arbor, MI (US)

(72) Inventors: Patrick Wiegand, Pinckney, MI (US); Ronald C. Fairchild, Ann Arbor, MI (US)

(73) Assignee: KAISER OPTICAL SYSTEMS INC., Ann Arbor, MI (US)

(21) Appl. No.: 14/282,780

(22) Filed: May 20, 2014

(51) Int. Cl. G06F 17/10; G01J 3/44

(52) U.S. Cl. CPC G06F 17/10; G01J 3/44

(57) ABSTRACT

Raw data inputs are treated as independent signal sources to reduce computational lag without adversely affecting signal-to-noise ratio (SNR). Applications include spectroscopy, multiple linear regression, mass balance quantitation and the calculation of physical properties. The input-specific averaging has been applied to Raman spectroscopy, where the inputs are averaged spectra from which peak heights or areas are obtained from integration. Alternatively, peak areas or heights can be obtained from unaveraged spectra and are then averaged before use in further calculations as inputs to produce a desired output. The output(s) are linear or nonlinear combinations of the peak heights or areas, coupled with weighting factors which relate the raw inputs to a quantitative output such as concentration of a chemical species. Each specific input can use a different type of averaging. The overall goal may be optimization for best precision, and/or optimization for minimum lag time.

### FIELD OF THE INVENTION

This invention relates generally to quantitative analysis methods and, in particular, to a method of treating raw data as independent signal sources to reduce computational lag without adversely affecting signal-to-noise ratio (SNR).

### BACKGROUND OF THE INVENTION

A class of quantitative analysis methods involves collection of one or more raw data inputs, which are combined in a linear or nonlinear fashion to produce one or more outputs. For example, one method class is called a weighted sum and has the following equation for conversion of inputs to outputs:

R₁I₁+R₂I₂+R₃I₃+ . . . +RₙIₙ=W Equation 1

where:

Rₙ equals the response factor, or input weighting, for input n

Iₙ equals input n, and

W equals the weighted sum of the inputs, i.e., the output

These inputs typically have their own statistical characteristics, such as error distribution and mean. In most cases, it is desirable to have a high signal-to-noise ratio in the output, which is normally produced by averaging multiple sequential outputs over time:

W_{avg}=Σₚ₌₁^{N}(Wₚ)/N Equation 2

where W_{avg} equals the average output over the time period from point 1 to point N of the individual outputs Wₚ.

This approach, however, has the unwanted side effect of increasing the lag time for the output because each individual Wₚ must be measured before the first W_{avg} is available. While the signal-to-noise of W_{avg} is increased by a factor equivalent to the square root of N, (the number of points averaged), this conflict between increased signal-to-noise and increased lag time is of a general nature and is difficult to overcome.

If all of the inputs for these additional calculations are averaged identically, then the lag time will be equal to the time period of an individual measurement times the number of measurements averaged, and will be carried over into the calculation of the new output. This lag time—when all inputs are averaged equally—is identical to that which would result if the output were averaged directly.

Many literature and patent references exist with respect to a constant width moving-window average of output quantities, as well as weighted variants such as linear regression, Savitsky-Golay smoothing, and so forth. However, no work has been found in which the raw inputs to a calculation producing an output are treated independently.

### SUMMARY OF THE INVENTION

This invention is broadly directed to a method of reducing computational lag without adversely affecting signal-to-noise ratio (SNR) in a system wherein raw data inputs are combined in a linear or nonlinear manner to produce one or more outputs. A plurality of raw data inputs are received at a computer processor, wherein one or more of the data inputs exhibits an inherently high SNR, and one or more of the data inputs exhibits an inherently low SNR. An averaging factor is applied to each data input on an independent basis that is a function of the SNR for that input, and the inputs are combined following the application of the averaging factor to produce one or more outputs. In a preferred embodiment, the computer processor does not average raw data inputs exhibiting the inherently high SNR.

Each data input may represent a plurality of data points having a fixed error distribution and mean, in which case the computer processor may apply a constant averaging factor to each data input as a function of the number of data points for that input. The data inputs may be averaged starting from the most recent value received, working backwards until a desired error is obtained or until a predetermined limiting averaging factor is reached. Alternatively, the averaging is carried out using an adaptive infinite impulse response filter, with the weight of each new input point being added to the running average input is determined by the difference between the new input point and the running average.

The data inputs having an inherently low signal-to-noise ratio represent material concentrations that are small or unchanging. In one disclosed example, the data inputs may represent Raman spectra. In particular, the data inputs may be averaged Raman spectra from which peak heights or areas are obtained through integration. The peak heights or areas may be obtained from unaveraged spectra then averaged before use in further calculations as inputs to produce one or more desired outputs. The output(s) may be linear or nonlinear combinations of the peak heights or areas, coupled with weighting factors which relate the raw inputs to a quantitative output such as concentration of a chemical species.

### BRIEF DESCRIPTION OF THE DRAWINGS

FIG. 1 shows an example of a Raman spectrum with scattered light intensity on the Y axis and wavelength expressed as Raman Shift in wavenumbers on the x axis;

FIG. 2 shows a blown up section of FIG. 1 showing individual data points consisting of an intensity value on the Y axis at each wavenumber value on the X axis;

FIG. 3 shows a spectral peak with noisy background and three attempts to draw a baseline. Area A+Area B equals true area;

FIG. 4 shows a high signal-to-noise peak. Baseline errors have been exaggerated for clarity;

FIG. 5 shows ten consecutive spectra overlaid. The peak between the vertical bars is due to nitrogen. The vertical bars represent the integration limits for the peak. Drawing a baseline from where the spectrum crosses the left vertical bar to where it crosses the right vertical bar results in different baselines, and thus different areas, when in fact the areas should be approximately the same;

FIG. 6 shows the average of the same ten spectra shown in FIG. 5. The baseline is drawn closer to the true baseline for peak;

FIG. 7 shows the successive measurements of unchanging sample over a two-hour period. Dotted line: no averaging. Solid line: all components averaged using previous 10 spectra. Long dashed line: only pentanes and nitrogen based on averaged spectra. Short dashed line: pentanes and nitrogen based on averaged areas from unaveraged spectra;

FIG. 8 shows variability of the four approaches described in FIG. 7 quantitatively expressed as standard deviations of the methane mol %;

FIG. 9 shows methane concentration showing a step change in composition. Solid line: all components averaged equally, lag=30 min. Others (overlapped): negligible lag; and

FIG. 10 shows same time period as FIG. 9, except showing behavior of nitrogen. Dotted line: no averaging. Solid line: all components based on 10-spectrum average. Long dashed line: pentanes and nitrogen only based on 10-spectrum average. Short dashed line: pentanes and nitrogen based on averaged areas from non-averaged spectra.

### DETAILED DESCRIPTION OF THE INVENTION

An alternative approach, which is the subject of this invention disclosure, is to treat each of the inputs as an independent signal source and apply averaging that is specific to each signal source in such a fashion as to produce both a high signal-to-noise and a minimum lag time in the output. This can be accomplished because some inputs have an inherently higher signal-to-noise and require little, if any, averaging. Other inputs may have inherently low signal-to-noise, but because their concentrations are small and/or unchanging, can be averaged with little effect on the overall lag time of the output.

In one embodiment of the invention, the error distribution and mean of each input are assumed to be fixed and thus a constant averaging factor, optimized for each input, can be used. This is often called a “boxcar average” or “moving-window average” and is common in the industry when used on the outputs. The characteristic descriptor of a moving-window average is the size (in points) of the window, i.e., the number of points to be averaged. In this invention, each moving-window average can have a different number of points that is appropriate for the specific input with the resulting goal of optimizing both the precision and lag time of the output.

In another embodiment, the averaging factor can be based on the current error distribution of the signal itself. In this embodiment, the inputs are averaged starting from the most recent value and working backwards until the desired error is obtained, or a predetermined limiting averaging factor is reached. Again, the averaging is optimized for each input. This embodiment would be preferred when the precision of the output is of more importance than the lag time.

In a third embodiment, the averaging is done by an adaptive infinite impulse response filter, where the weight of the new input point being added to the running average input is determined by the difference between the new input point and the running average. This is shown in Equation 4.

$${LA}_{n} = \frac{( \frac{E}{D} ) * CP + {LA}_{n - 1}}{\frac{E}{D} + 1} \qquad Equation 4$$

Where: E is an estimate of the error of the input, such as its standard deviation

LA is the last averaged point, i.e. the running average

CP is the current input point before averaging

D is the absolute difference between LA and CP

This type of average allows lag time to be reduced to zero when the signal is changing very slowly, and at the same time is very good at rejecting sudden movements in an input, such as a spurious signal or spike. When D is about the same as the expected error, about half the weight is given to the new point and half to the running average. When D becomes much smaller than E, the new point essentially becomes the new average. When D becomes much larger than E, the new point is essentially rejected. Algorithm means are used to catch the cases where D is zero or when a permanent step-change occurs that is beyond the normal expected error. Other averaging schemes, such as weighted moving-average, linear regression averaging, and so forth can also be used.

### Application to Spectroscopy

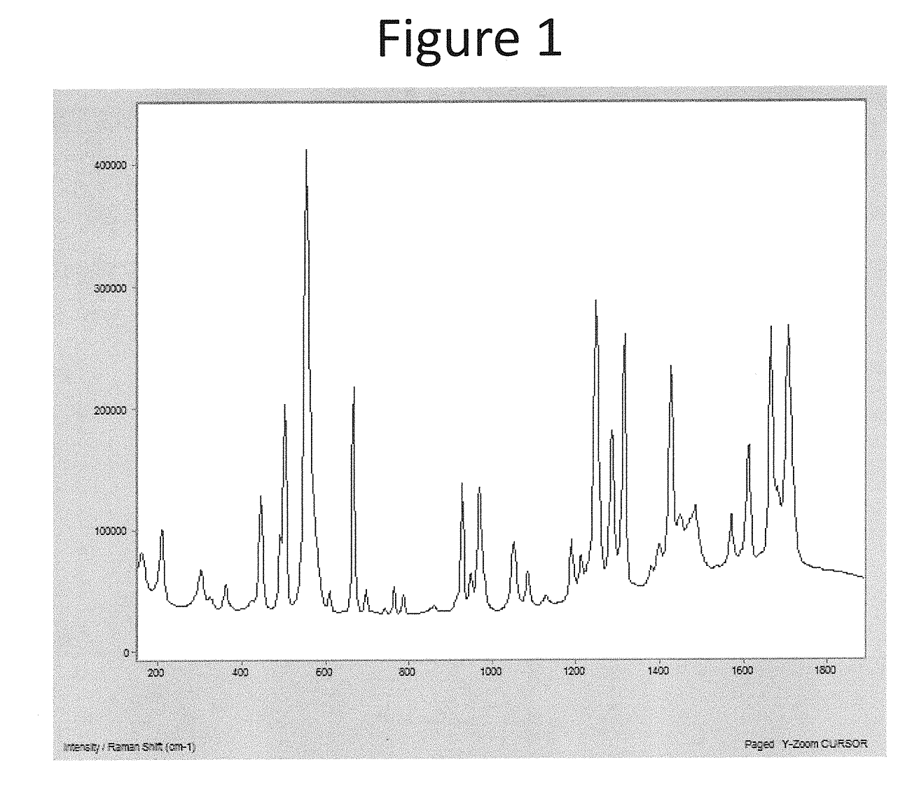

Spectroscopy involves generating the raw data, or inputs, as individual points consisting of some measure of light intensity vs. wavelength. For example, in absorbance spectroscopy, the light intensity is expressed as the log of the percent transmittance of light through a sample and the wavelengths may be expressed in nanometers, for near-infrared, or inverse centimeters, also called wavenumbers, for the mid-infrared range. For types of spectroscopy involving scattered light, such as Raman spectroscopy, the light intensity is measured as raw counts from the digitization of a detector signal. For Raman spectroscopy, the wavelength is expressed as a wavenumber shift from the incident light source which stimulated the Raman scattering. An example Raman spectrum is shown in FIG. 1.

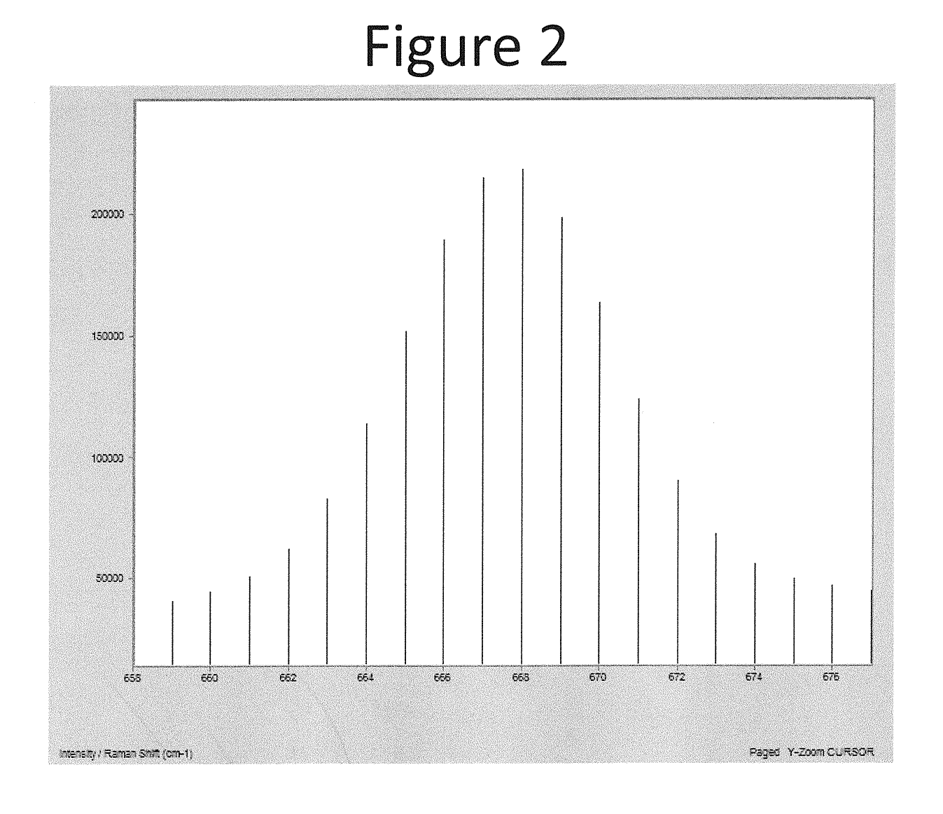

Enlarging a small region of the spectrum in FIG. 1 produces FIG. 2, where individual points, or inputs, can be seen. FIG. 2 is a representation of a type of object in a spectrum called a peak. The peak is actually a single spectroscopic quantity representing the light intensity given off by a specific number of molecules in a sample. The bigger the peak, the more molecules are present, which is the underlying basis of spectroscopic quantitation. However, the raw data input has multiple points defining the peaks shape. Each of these points is a measured quantity of detector response and has error associated with its measurement.

Application of Equation 1 to the raw inputs, where each Rₙ is equal to 1, will give the absolute peak area. Thus the peak area can be considered a type of output for spectroscopic quantitation. It is relatively easy to see that each Rₙ could be chosen as some number other than 1, such that the sum would be a concentration value instead of a peak area with units of counts.

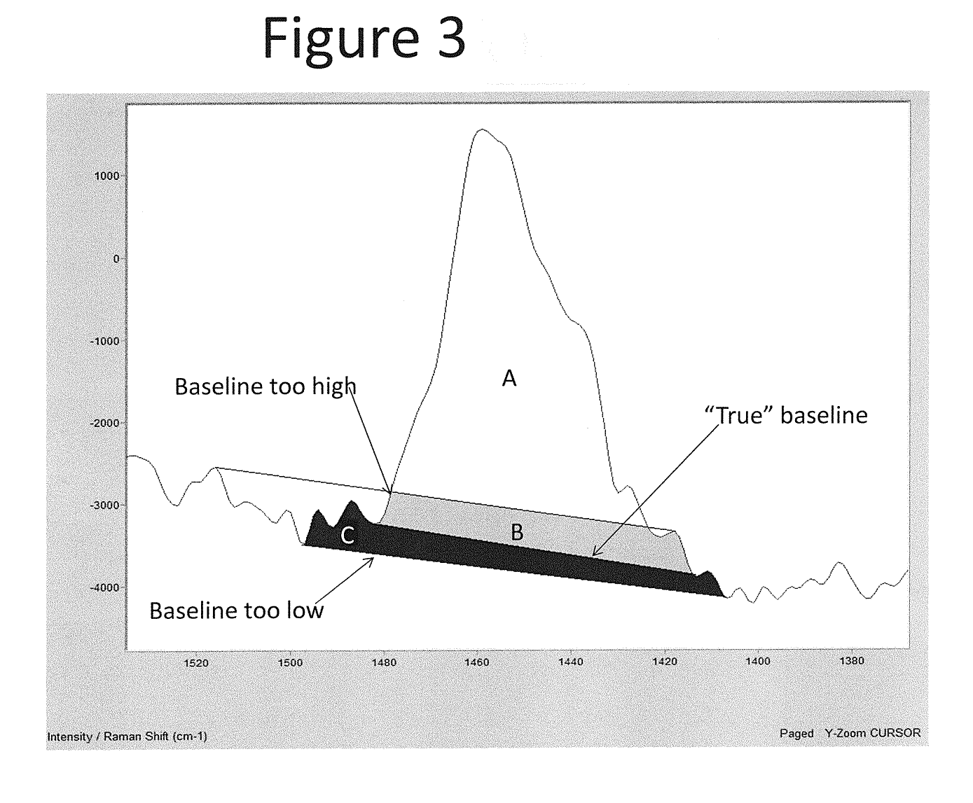

The reader may notice that the peak shape appears to flatten as one gets closer to the edges of the plot in FIG. 2. Often this flattening is due to residual signal from the detector background that has nothing to do with the number of molecules in the sample. Normally a linear baseline is drawn, in this case from point 658 to point 677, and that area is subtracted from the total area of the peak. If the baseline is drawn correctly, then the remaining area better represents the number of molecules in the sample. If the baseline is drawn incorrectly, for example too high or too low, then the remaining area will be too small or too large respectively and the quantitation will be in error. The less noise in the raw data inputs, the easier it will be to draw the baseline correctly. This is demonstrated in FIG. 3.

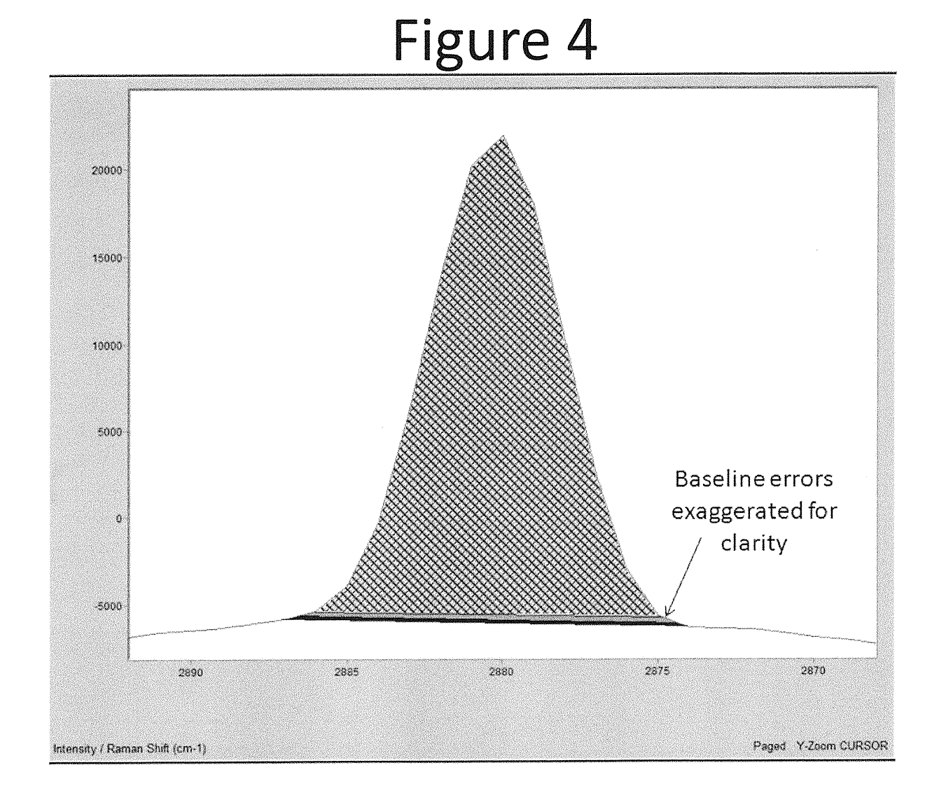

In the case where peaks are very large with respect to the background (a high signal-to-noise), the effect of drawing the baseline slightly wrong has little effect on the area of the peak. This is shown in FIG. 4, which comes from the same spectrum as FIG. 3 but represents a high concentration of molecules, producing a peak with area much greater than the background.

It should be apparent that in the case of FIG. 3, it may be acceptable to pay the price of a longer lag time for the output by averaging multiple spectra to decrease the noise on the individual inputs composing the baseline so that the baseline can be drawn correctly. For FIG. 4, however, the signal-to-noise of the peak is already high, and slight errors in the way the baseline is drawn have little effect on the peak area. Unfortunately, since both peaks are members of the same set of raw input data (the spectrum from a single sample), imposing averaging and the resultant long lag time for the sake of better quantitation of the peak in FIG. 3 also imposes the lag time for the peak in FIG. 4, even though averaging is not needed for this peak. Note that this problem is carried over into further calculations. Just as the raw data inputs can be combined to produce an output called a peak, individual peak areas can then be used as inputs to other equations to calculate additional quantities.

### Application to Multiple Linear Regression

In spectroscopy there may be an instance where molecule A has a peak close to a peak from molecule B (peak B₁) such that the area of peak A always includes some area from peak B₁, i.e. the peaks are overlapped (peak AB₁. If there is an additional peak for molecule B, e.g, peak B₂, this peak area can be used to calculate the correct area of peak A. Equation 1 is applied in such a manner that the R for peak AB₁ is positive and the R for peak B₂ is negative, which results in the true peak area for A being calculated by subtracting some area of the overlapped peak AB₁. This technique is called multiple linear regression and is often used in spectroscopy to quantitate molecular composition when there are no unoverlapped peaks for a particular component.

### Application to Mass Balance Quantitation

Another common example of multiple peaks being used in a calculation is called mass balancing. In this case, the sum of the concentrations of all components in a mixture is known to add to 100%. However, for many reasons, the sum as measured may add to more or less than 100%. A simple correction is to normalize each concentration by dividing by the sum of the concentrations, which results in the new normalized sum adding to unity, or when multiplied by 100, adding to 100% (see Equation 3):

$${C}_{1}^{norm} = \frac{{C}_{1} + {C}_{2} + … + {C}_{n}}{{\sum }_{i = 1}^{n} {C}_{i}} \times 100 \% \qquad Equation 3$$

Where Cᵢ is the concentration of an individual component before normalization. Because of the nature of the sum in the denominator of Equation 3, errors from every component are carried through the calculation and affect the error of every resulting normalized concentration. This is true regardless of whether spectra are averaged and then a peak area is calculated or whether peak areas are calculated from unaveraged spectra and then averaged afterward.

### Application to Calculation of Physical Properties

Another example of peak areas being used as inputs for calculation of another quantity is when the quantity is a physical property of the sample. In these cases the assumption is that the physical property of the sample can be related to some combination of the peak areas. Using multiple linear regression, R values are calculated for each peak such that the weighted sum of peak areas equals the physical property of the mixture. For example, in the Liquified Natural Gas industry, heating value is calculated by determining the molecular composition and then assigning a heating value for each molecule such that the total heating value is a weighted sum of the specific molecules heating value times the specific molecule's concentration. Since concentration is simply a weighted sum of peak areas we can see that peak area inputs can be used to determine outputs of physical properties such as heating value.

### Examples

The technique was applied to spectra obtained from liquified natural gas (LNG) consisting of the approximate composition shown in Table I. Moving-window averaging was used on the spectra and compared with moving-window averaging on the areas from unaveraged spectra. In addition, results are shown for no averaging and the case where all components have the same averaging applied, which is mathematically the same as averaging the output, a practice well-known in the industry.

TABLE I
Molecular composition of liquified natural gas example.

| | Methane | Ethane | Propane | Isobutane | Butane | Isopentane | Pentane | Neopentane | Nitrogen |
|---|---|---|---|---|---|---|---|---|---|
| Mol % | 96 | 4.2 | 0.11 | 0.038 | 0.013 | 0.0064 | 0.0025 | 0.0020 | 0.080 |

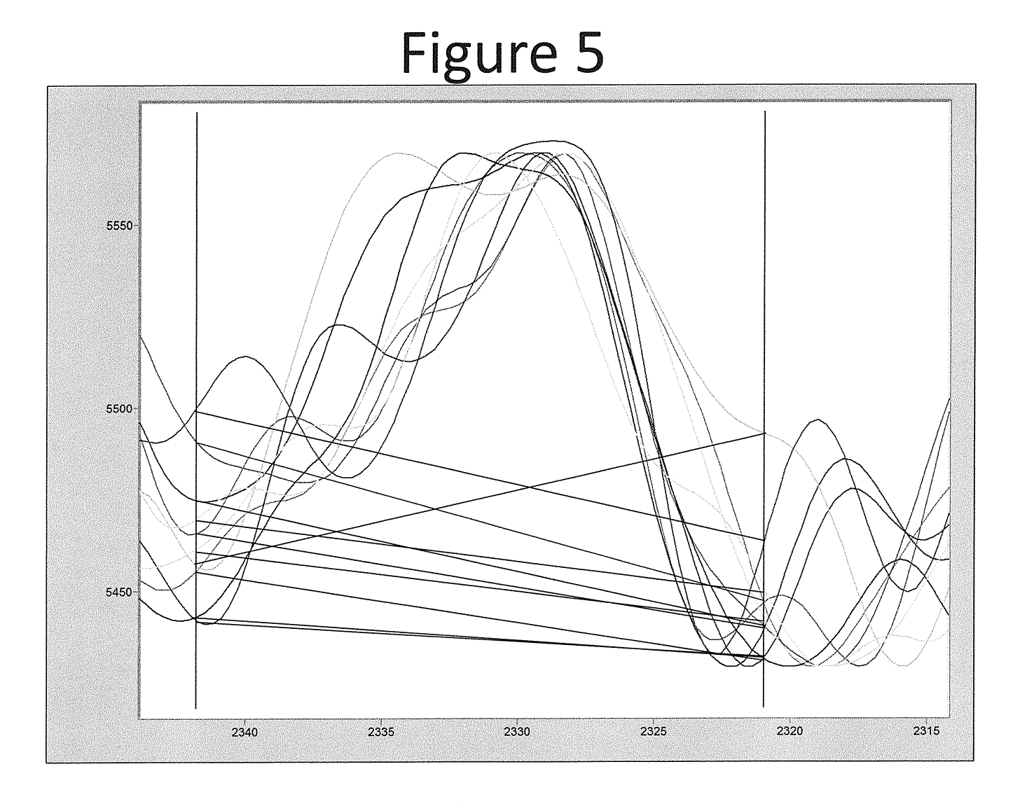

The peaks which could benefit the most from averaging are the four lowest concentration peaks: Isopentane, Pentane, Neopentane and Nitrogen. FIG. 5 shows 10 consecutive peaks for Nitrogen, showing the problems caused by noise, which results in the baseline being drawn differently for each spectrum.

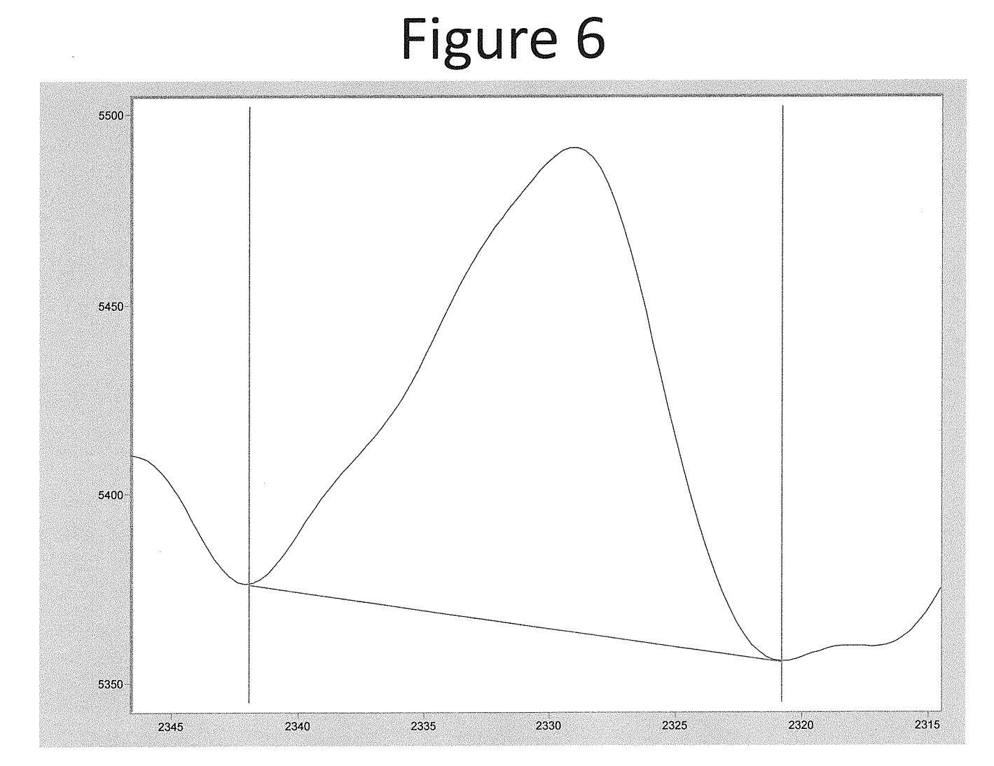

FIG. 6 shows the average of the same 10 spectra. In this case, the noise is dramatically reduced and the baseline can be drawn with more reproducibility.

FIGS. 5 and 6 show that averaging spectra can produce a more reliable measurement of peak area, and thus nitrogen concentration. Note that a similar improvement can often be obtained by averaging the individual peak areas from FIG. 5 to obtain the peak area shown in FIG. 6.

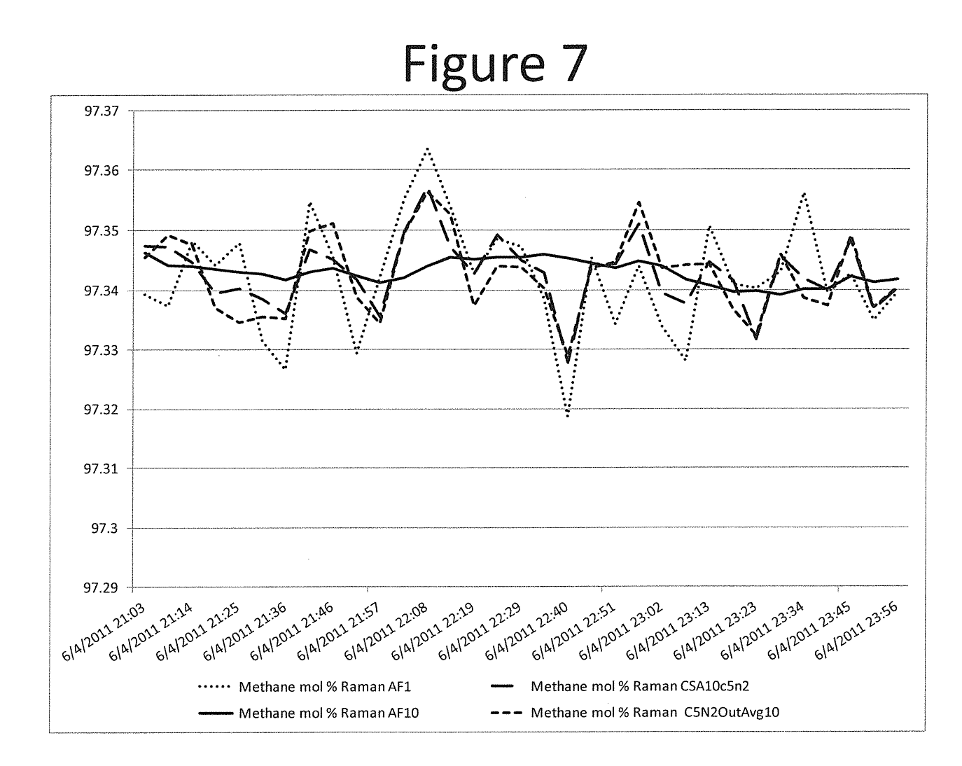

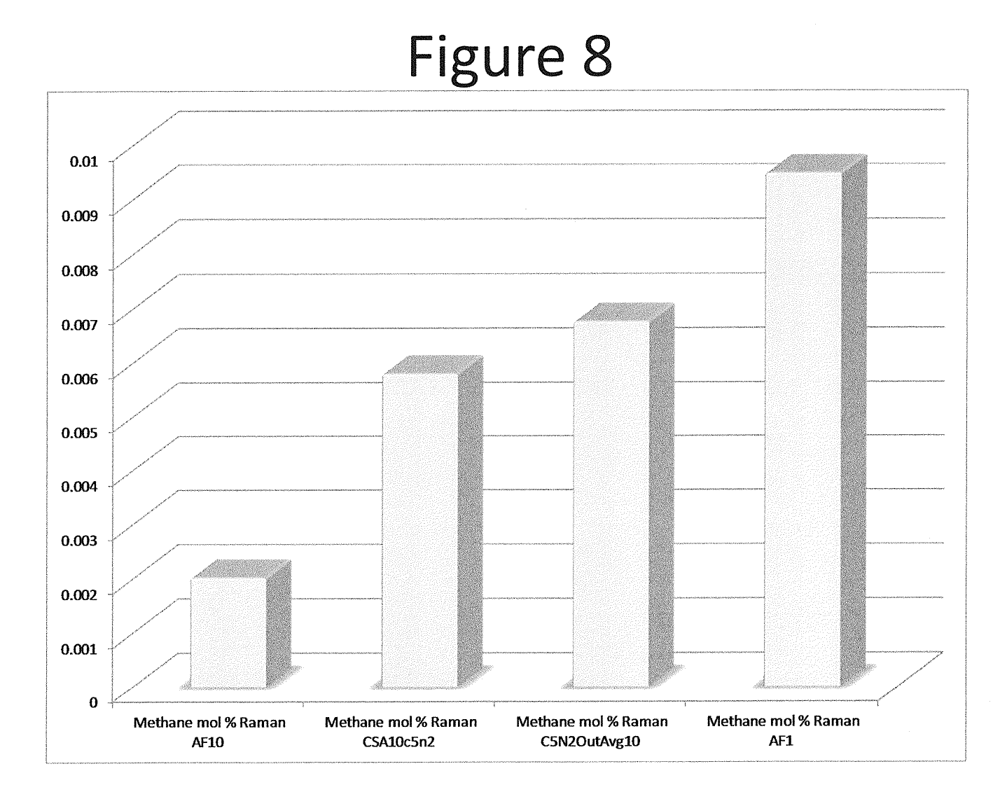

The technique will be applied to the calculation of Mol % Methane in the sample, which is the major component. FIG. 7 shows the analysis of consecutive measurements over a two-hour time period in which the sample is unchanging. Four approaches are shown on the graph. The green line, labeled AF1, refers to the base case where no averaging is being performed on any input. As expected this has the most variability. The blue line is the other extreme, labeled AF10, where all inputs, including the methane, have an averaging factor of 10, meaning that the peak areas are being calculated by averaging the previous 10 spectra together. As expected, this has the least variability. The other two cases have only the minor components isopentane, normal pentane, neopentane and nitrogen being averaged. In the case labeled CSA10c5n2 (purple), the peak areas were calculated from averaged spectra. In the case of the orange line, labeled C5N2OutAvg10, the peak areas were calculated from unaveraged spectra and then averaged, again using the last 10 measurements. Even though the major component, methane, has a very high signal-to-noise, an improvement in variability is seen with both ways of averaging the minor components. The variability is quantified in FIG. 8.

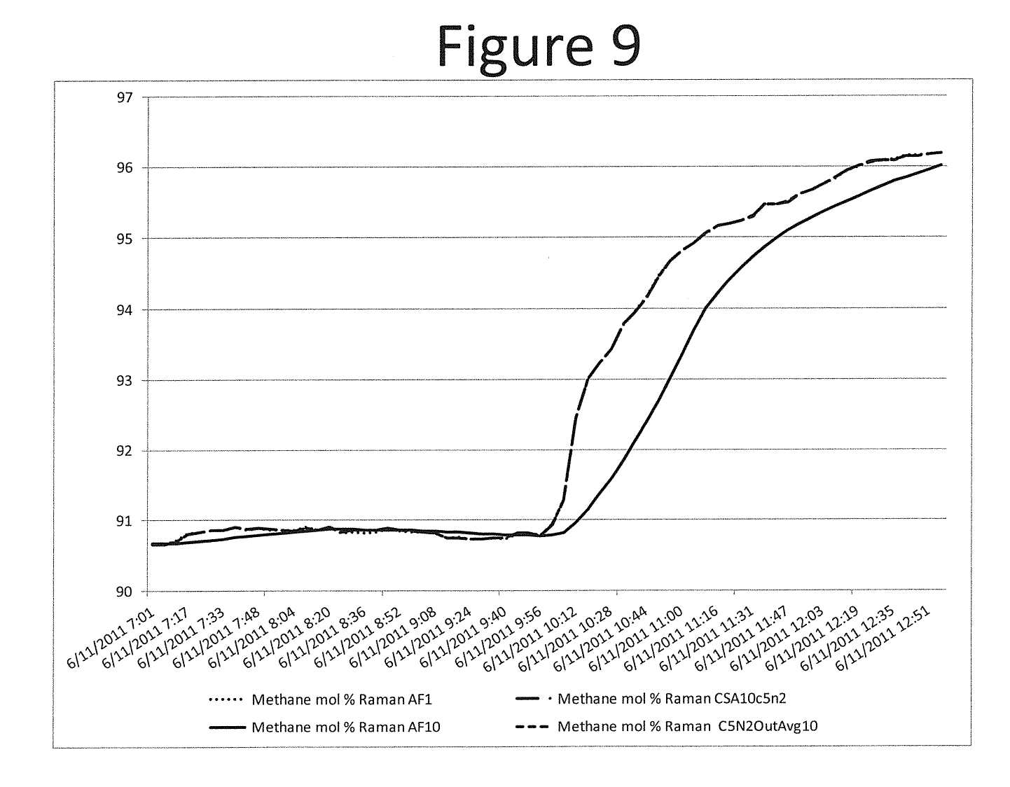

Next we examine the same four approaches, except in this instance a different time period is displayed. In this time period the composition of liquified natural gas undergoes a sharp step change. The case where all components are averaged equally shows a lag of about 30 minutes (blue line). The other approaches almost perfectly overlap at this scale and show negligible lag (FIG. 9).

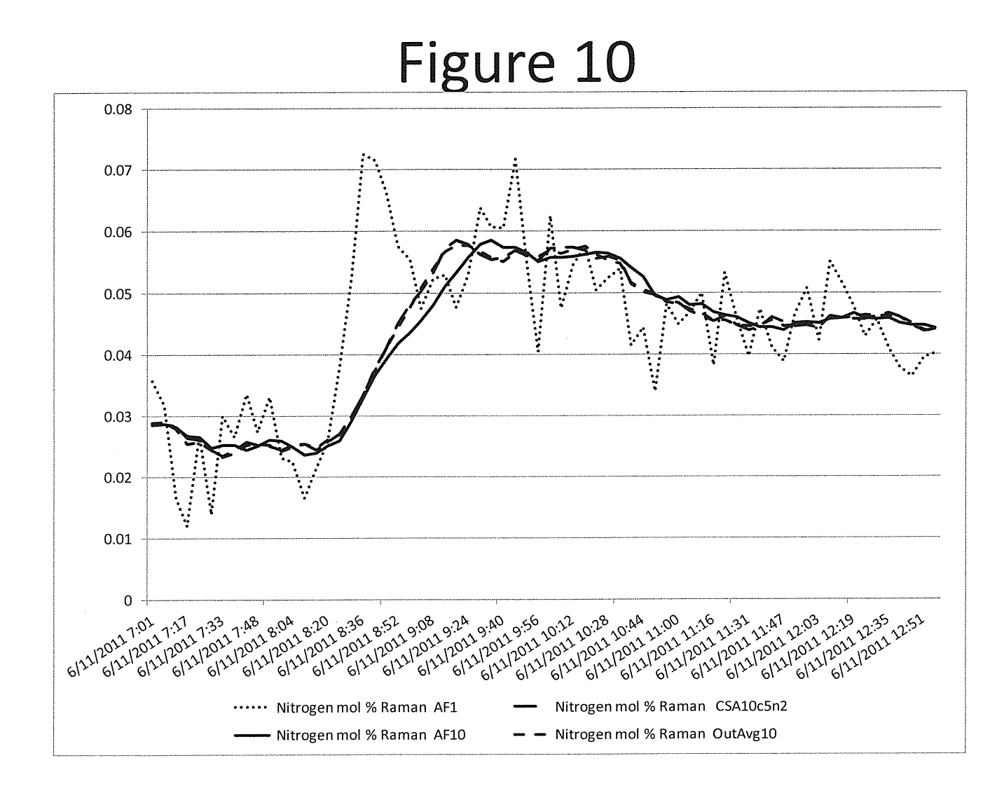

Looking at a minor component (FIG. 10), all forms of averaging show some lag, as expected. However, the case for all components being averaged equally shows more lag than component-specific averaging. In terms of variability, however, component-specific averaging shows approximately the same precision as averaging all components.

1. A method of reducing computational lag without adversely affecting signal-to-noise ratio (SNR) in a system wherein raw data inputs are combined in a linear or nonlinear manner to produce one or more outputs, the method comprising the steps of:
receiving a plurality of raw data inputs at a computer processor, wherein one or more of the data inputs exhibits an inherently high SNR, and one or more of the data inputs exhibits an inherently low SNR;
applying an averaging factor by the computer processor to each data input on an independent basis that is a function of the SNR for that input; and
combining the inputs following the application of the averaging factor to produce one or more outputs.

2. The method of claim 1, wherein the computer processor does not average raw data inputs having an inherently high SNR.

3. The method of claim 1, wherein:
each data input represents a plurality of data points having a fixed error distribution and mean; and
the computer processor applies a constant averaging factor to each data input as a function of the number of data points for that input.

4. The method of claim 1, wherein the data inputs are averaged starting from the most recent value received, working backwards until a desired error is obtained or until a predetermined limiting averaging factor is reached.

5. The method of claim 1, wherein:
the averaging is carried out using an adaptive infinite impulse response filter; and
the weight of each new input point being added to the running average input is determined by the difference between the new input point and the running average.

6. The method of claim 1, wherein the data inputs having an inherently low signal-to-noise ratio represent material concentrations that are small or unchanging.

7. The method of claim 1, wherein the data inputs represent Raman spectra.

8. The method of claim 7, wherein the data inputs are averaged Raman spectra from which peak heights or areas are obtained through integration.

9. The method of claim 8, wherein the peak heights or areas are obtained from unaveraged spectra then averaged before use in further calculations as inputs to produce one or more desired outputs.

10. The method of claim 9, wherein the output(s) are linear or nonlinear combinations of the peak heights or areas, coupled with weighting factors which relate the raw inputs to a quantitative output such as concentration of a chemical species.

11. A method of reducing computational lag without adversely affecting signal-to-noise ratio (SNR) in a system wherein raw data inputs representing Raman spectra are combined in a linear or nonlinear manner to produce one or more outputs, the method comprising the steps of:
inputting data representative of Raman spectra at a computer processor, wherein one or more of the spectra exhibits an inherently high SNR, and one or more of the spectra exhibits an inherently low SNR;
applying an averaging factor by the computer processor to the input spectra on an independent basis that is a function of the SNR for that input; and
combining the input spectra following the application of the averaging factor to produce one or more outputs.

12. The method of claim 11, wherein the data inputs are averaged Raman spectra from which peak heights or areas are obtained through integration.

13. The method of claim 12, wherein the peak heights or areas are obtained from unaveraged spectra then averaged before use in further calculations as inputs to produce one or more desired outputs.

14. The method of claim 13, wherein the output(s) are linear or nonlinear combinations of the peak heights or areas, coupled with weighting factors which relate the raw inputs to a quantitative output such as concentration of a chemical species.
